(19) United States
(12) Patent Application Publication
(10) Pub. No.: US 2016/0365042 A1
(43) Pub. Date: Dec. 15, 2016

(54) Display Driver Circuitry With Gate Line and Data Line Delay Compensation

(71) Applicant: Apple Inc., Cupertino, CA (US)

(72) Inventors: Fenghua Zheng, San Jose, CA (US); Sandro H. Pintz, Menlo Park, CA (US)

(21) Appl. No.: 14/740,057

(22) Filed: Jun. 15, 2015

(51) Int. Cl. G09G 3/36

(52) U.S. Cl. CPC G09G 3/36

(57) ABSTRACT

Gate driver circuitry in a display may supply gate line signals to rows of pixels on gate lines. Data line driver circuitry may supply data line signals to columns of pixels on data lines. The gate driver circuitry may have registers that are coupled to form a shift register that supplies the gate line signals to the gate lines. To compensate for data line signal propagation delays, the registers of the shift register may be clocked with increasingly delayed clocks as a function of increasing distance away from the display driver circuitry. To compensate for gate line signal propagation delays, the data line driver circuitry may impose increasing delays on the data line signals carried on the data lines as a function of increasing distance of the data lines away from the gate driver circuitry.

### BACKGROUND

This relates generally to electronic devices, and, more particularly, to electronic devices with displays.

Electronic devices such as cellular telephones, computers, and other electronic equipment often contain displays. A display includes an array of pixels for displaying images to a user. Display driver circuitry such as data line driver circuitry may supply data signals to the array of pixels. Gate line driver circuitry in the display driver circuitry can be used to assert a gate line signal on each row of pixels in the display in sequence to load data into the pixels.

It can be challenging to uniformly load data into the pixels of a display. The times at which the leading and trailing edges of a data line signal occur are different across the display. Due to propagation delays along the data lines, pixels at locations close to the data line driver circuitry may receive data line signals with minimal delay, whereas pixels at locations far from the data line driver circuitry may receive data line signals with larger amounts of delay. Gate line signals can also be affected by propagation delays. Pixels at locations close to the gate line driver circuitry may receive undelayed signals whereas pixels at locations far from the gate line driver circuitry may receive gate line signals with delays.

During data loading operations for each row of pixels, the gate line signal for that row of pixels is asserted, turning on associated thin-film transistors in the pixels and loading data from corresponding data lines into the pixels. Because gate line signals can experience location-dependent gate line delays and because data line signals can experience location-dependent data line delays, the desired timing relationships between date line signals and gate line signals may be disrupted. If care is not taken, there may not be sufficient data loading time (charging time) for certain pixels or a data line signal may become invalid for a pixel before the gate line signal for that pixel has been deasserted. As a result, data loading operations may not be performed satisfactorily for a display.

It would therefore be desirable to be able to provide displays with improved gate line and data line driver circuitry.

### SUMMARY

A display may have an array of pixels controlled by display driver circuitry. Gate driver circuitry may supply gate line signals to rows of the pixels on gate lines. The gate driver circuitry may have registers that form a shift register to supply the gate line signals to the gate lines. Data line driver circuitry may supply data line signals to columns of the pixels on data lines. The pixels may be liquid crystal display pixels each of which has a thin-film transistor with a gate that receives one of the gate line signals to control the application of a data line signal to a respective portion of a liquid crystal layer.

The gate line signals may experience propagation delays when traveling away from the gate line driver circuitry on the gate lines. The data line data line signals may experience propagation delays when traveling away from the data line driver circuitry on the data lines.

To compensate for data line signal propagation delays, the registers of the shift register may be clocked with increasingly delayed clocks as a function of increasing distance way from the display driver circuitry. To compensate for gate line signal propagation delays, the data line driver circuitry may impose increasing delays on the data line signals carried on the data lines as a function of increasing distance of the data lines away from the gate driver circuitry.

### BRIEF DESCRIPTION OF THE DRAWINGS

FIG. 1 is a schematic diagram of an illustrative electronic device having a display in accordance with an embodiment.

FIG. 2 is a top view of an illustrative display in an electronic device in accordance with an embodiment.

FIG. 3 is a circuit diagram of an illustrative pixel circuit in a display in accordance with an embodiment.

FIG. 4 is a diagram of a display showing the locations of four illustrative sets of pixels that have the potential to experience different gate line delays and data line delays during operation of the display in accordance with an embodiment.

FIG. 5 is a timing diagram showing how gate line delays and data line delays may arise in a conventional display.

FIG. 6 is a circuit diagram of illustrative gate line driver circuitry in accordance with an embodiment.

FIG. 7 is a timing diagram showing how gate line signals may be adjusted by the display driver circuitry of a display to reduce location-dependent gate line delays in accordance with an embodiment.

FIG. 8 is a timing diagram showing how data line signals may be adjusted by the display driver circuitry of a display to reduce location-dependent data line delays in accordance with an embodiment.

### DETAILED DESCRIPTION

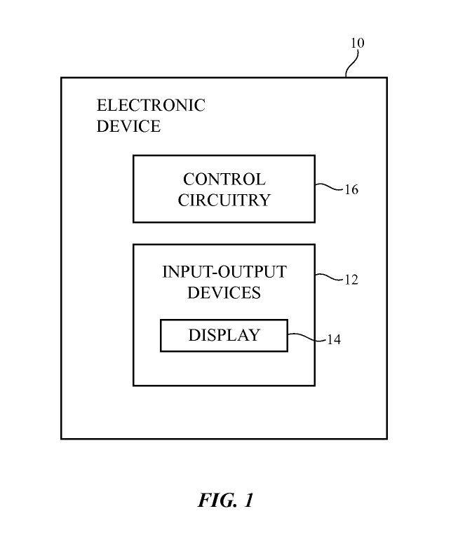

An illustrative electronic device of the type that may be provided with a display is shown in FIG. 1. As shown in FIG. 1, electronic device 10 may have control circuitry 16. Control circuitry 16 may include storage and processing circuitry for supporting the operation of device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 16 may be used to control the operation of device 10. The processing circuitry may be based on one or more microprocessors, microcontrollers, digital signal processors, baseband processors, power management units, audio chips, application specific integrated circuits, etc.

Input-output circuitry in device 10 such as input-output devices 12 may be used to allow data to be supplied to device 10 and to allow data to be provided from device 10 to external devices. Input-output devices 12 may include buttons, joysticks, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices 12 and may receive status information and other output from device 10 using the output resources of input-output devices 12.

Input-output devices 12 may include one or more displays such as display 14. Display 14 may be a touch screen display that includes a touch sensor for gathering touch input from a user or display 14 may be insensitive to touch. A touch sensor for display 14 may be based on an array of capacitive touch sensor electrodes, acoustic touch sensor structures, resistive touch components, force-based touch sensor structures, a light-based touch sensor, or other suitable touch sensor arrangements.

Control circuitry 16 may be used to run software on device 10 such as operating system code and applications. During operation of device 10, the software running on control circuitry 16 may display images on display 14 using an array of pixels in display 14.

Device 10 may be a tablet computer, laptop computer, a desktop computer, a display, a cellular telephone, a media player, a wristwatch device or other wearable electronic equipment, or other suitable electronic device.

Display 14 may be an organic light-emitting diode display, a liquid crystal display, or a display based on other types of display technology. Configurations in which display 14 is a liquid crystal display may sometimes be described herein as an example.

Display 14 may have a rectangular shape (i.e., display 14 may have a rectangular footprint and a rectangular peripheral edge that runs around the rectangular footprint) or may have other suitable shapes. Display 14 may be planar or may have a curved profile.

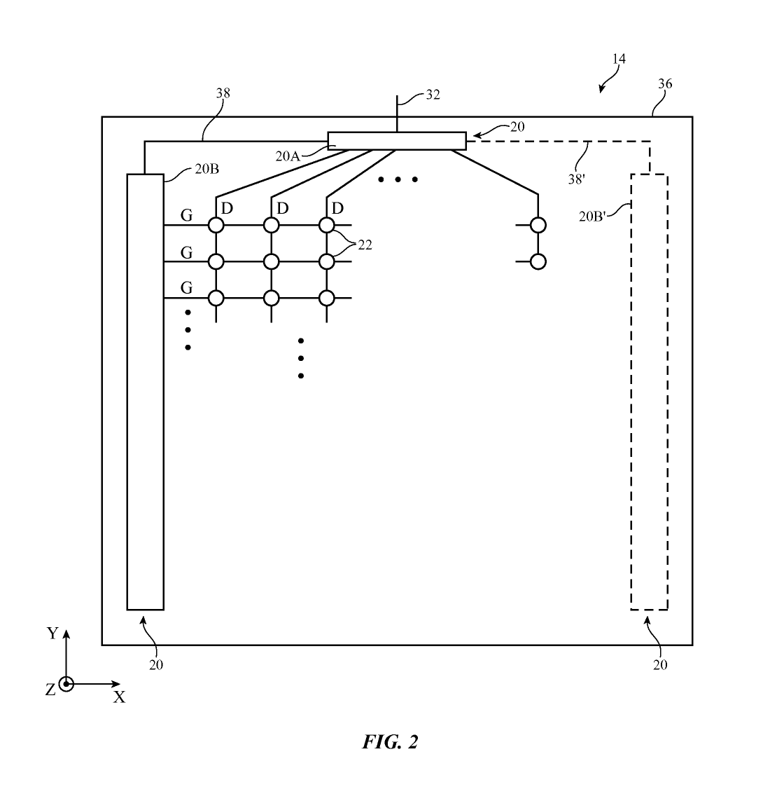

A top view of a portion of display 14 is shown in FIG. 2. As shown in FIG. 2, display 14 may have an array of pixels 22 formed from substrate structures such as substrate 36. Substrates such as substrate 36 may be formed from glass, metal, plastic, ceramic, or other substrate materials. Pixels 22 may receive data signals over signal paths such as data lines D and may receive one or more control signals over control signal paths such as horizontal control lines G (sometimes referred to as gate lines, scan lines, emission control lines, etc.). There may be any suitable number of rows and columns of pixels 22 in display 14 (e.g., tens or more, hundreds or more, or thousands or more). In organic light-emitting diode displays, pixels 22 contain respective light-emitting diodes and pixel circuits that control the application of current to the light-emitting diodes. In liquid crystal displays, pixels 22 contain pixel circuits that control the application of signals to pixel electrodes that are used for applying controlled amounts of electric field to pixel-sized portions of a liquid crystal layer. The pixel circuits in pixels 22 may contain transistors having gates that are controlled by gate line signals on gate lines G.

Display driver circuitry 20 may be used to control the operation of pixels 22. Display driver circuitry 20 may be formed from integrated circuits, thin-film transistor circuits, or other suitable circuitry. Thin-film transistor circuitry may be formed from polysilicon thin-film transistors, semiconducting-oxide thin-film transistors such as indium gallium zinc oxide transistors, or thin-film transistors formed from other semiconductors. Pixels 22 may have color filter elements of different colors (e.g., red, green, and blue) to provide display 14 with the ability to display color images.

Display driver circuitry 20 may include display driver circuits such as display driver circuit 20A and gate driver circuitry 20B. Display driver circuit 20A, which may contain data line driver circuitry for supplying signals to data lines D, may be formed from one or more integrated circuits and/or thin-film transistor circuitry. Gate driver circuitry 20B, which may be used to supply signals to gate lines G, may be formed from integrated circuits or may be thin-film “gate-on-array” circuitry.

Display driver circuit 20A of FIG. 2 may contain communications circuitry for communicating with system control circuitry such as control circuitry 16 of FIG. 1 over path 32. Path 32 may be formed from traces on a flexible printed circuit or other conductive lines. During operation, the control circuitry (e.g., control circuitry 16 of FIG. 1) may supply circuit 20A with information on images to be displayed on display 14 over path 32.

To display the images on display pixels 22, data line driver circuitry (source line driver circuitry) in display driver circuitry 20A may supply image data to data lines D while issuing clock signals and other control signals to supporting display driver circuitry such as gate driver circuitry 20B over path 38. Circuitry 20A may supply clock signals and other control signals to gate driver circuitry 20B on one or both edges of display 14 (see, e.g., path 38′ and gate driver circuitry 20B′ on the right-hand side of display 14 in the example of FIG. 2).

Gate driver circuitry 20B may supply each gate line G with a gate line signal for controlling the pixels 22 of a respective row (e.g., to turn on transistors in pixels 22 when loading data from the data lines into pixel storage capacitors in those pixels from data lines D). During operation, frames of image data may be displayed by asserting a gate signal on each gate line G in the display in sequence. Shift register circuitry (e.g., a chain of registers) in gate driver circuitry 20B may be used in controlling the gate line signals.

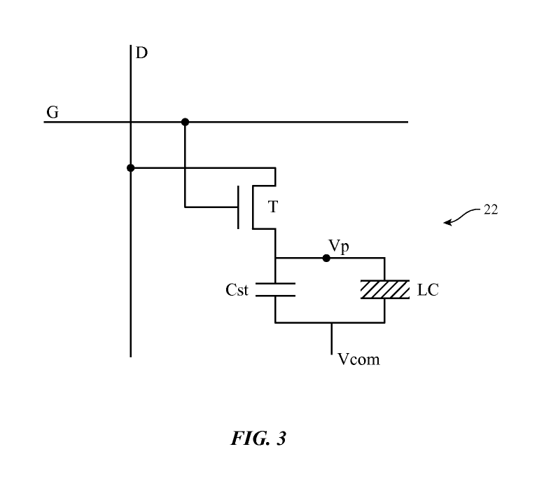

An illustrative pixel circuit for pixels 22 of display 14 is shown in FIG. 3. As shown in FIG. 3, each pixel 22 may include a pixel-sized portion of a liquid crystal layer LC to which electric fields may be supplied using corresponding pixel electrodes. The magnitude of the applied field is proportional to pixel voltage Vp minus common electrode voltage Vcom. During data loading operations, a desired data line signal (i.e., a data voltage Vp that is to be loaded into pixel 22) is driven onto data line D. The gate line signal on gate line G is asserted while the data line signal on data line D is valid. When the gate line signal is asserted, the gate of transistor T is taken high and transistor T is turned on. With transistor T turned on, data from line D is driven onto storage capacitor Cst and establishes pixel voltage Vp. Storage capacitor Cst maintains the value of Vp between successive image frames.

Satisfactory loading of a data line signal from data line D into pixel 22 under the control of the gate line signal on gate line G is dependent on maintaining appropriate timing relationships between the gate line signals (gate line pulses) and data line signals (data line pulses). If the gate line signals and data line signals for a given pixel are shifted by an undesired amount with respect to each other, there will be insufficient timing margin to ensure proper data loading. As an example, the gate line signal may be deasserted after a data line signal is no longer valid, leading to erroneous amounts of charge storage on capacitor Cst and incorrect values of pixel voltage Vp. As another example, if a gate line signal is deasserted too soon, a pixel may have an insufficient pixel charging time.

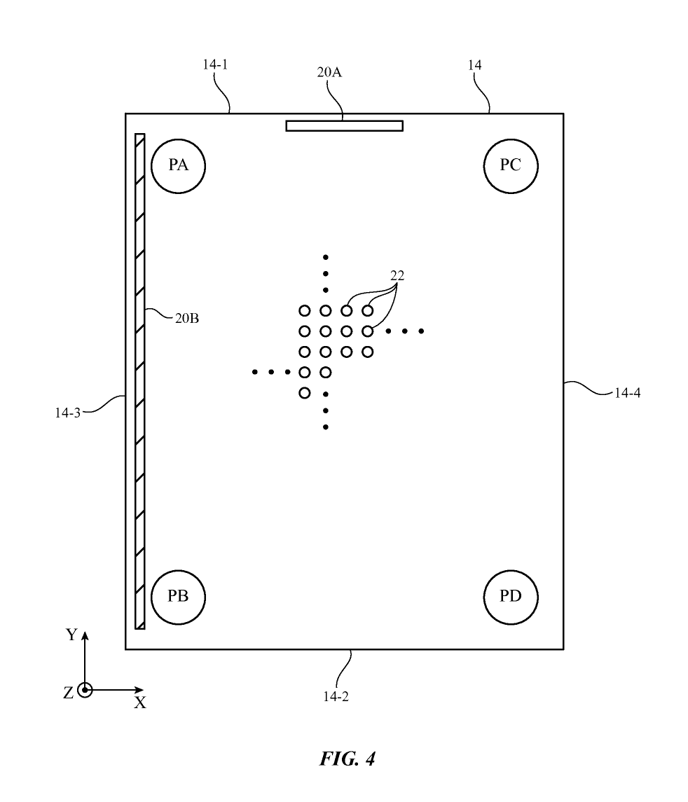

Ensuring that there are appropriate timing relationships between the gate lines signals and data line signals in a display may be particularly challenging in displays where there are significant signal propagation delays associated with conveying signals between different portions of the display. Consider, as an example, display 14 of FIG. 4. As shown in FIG. 4, display 14 may have an array of pixels 22 that are distributed in columns running along dimension Y and rows running along dimension X. Gate lines G may run horizontally along the rows of pixels 22 (i.e., along dimension X) and data lines D may run vertically along the columns of pixels 22 (i.e., along dimension Y).

With this type of configuration, pixels 22 in different locations on display 14 may receive data line signals and gate line signals at different times. For example, because pixels at locations PA and PC along upper edge 14-1 of display 14 are closest to data line driver circuitry 20A, the pixels at locations PA and PC will receive data line signals from data line driver circuitry 20A before the pixels at locations PB and PD along lower edge 14-2 of display 14 (i.e., locations PB and PD will experience data line propagation delays relative to locations A and C). Similarly, pixels 22 in positions PA and PB along the left edge of display 14 (i.e., the edge along which gate driver circuitry 20B runs) are closers to gate line driver circuitry 20B than pixels 22 in positions PC and PD along the right edge of display 14, so the pixels in positions PC and PD will experience gate line delays relative to the pixels in positions PA and PB.

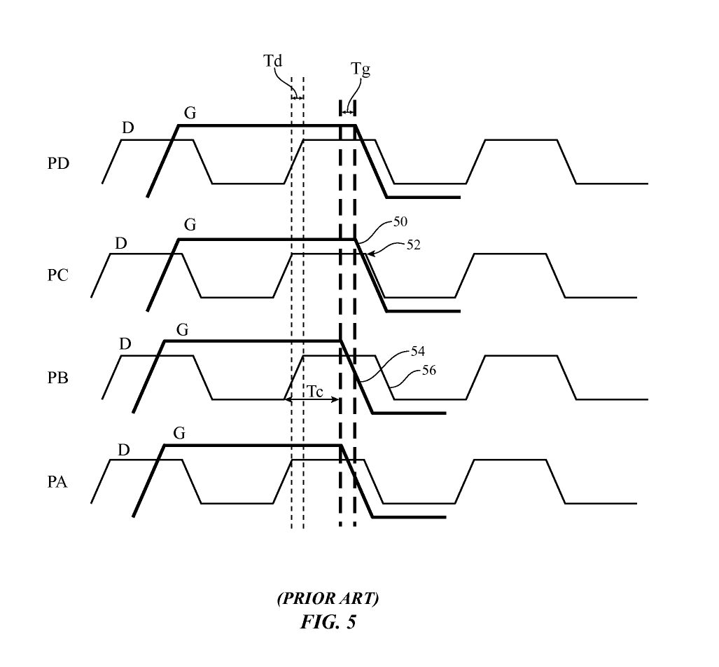

FIG. 5 is a timing diagram that shows how gate line delays and data line delays in a conventional display have the potential to create timing issues during data loading operations. There are four sets of signal traces in FIG. 5, one each for the data line signals D and gate line signals G of pixels at locations in a display such as locations PA, PB, PC, and PD of FIG. 4.

Due to the propagation time required to convey data signals from date line driver circuitry 20A along the data lines in display 14, there is a data line delay Td between the data line signal D for pixels at locations PA and PC (which have no data line delay) and the data line signal D for pixels at locations PB and PD (which are delayed by Td). Due to the propagation time required to convey gate line signals from gate line driver circuitry 20B along the gate lines in display 14, there is a gate line delay Tg between the gate line signals G for pixels at locations PA and PB (which have no gate line delay) and the gate line signals G for the pixels at locations PC and PD (which are delayed by Tg). This can lead to timing issues. For example, there is a risk that gate line signal G will be deasserted after the signal on data line D is no longer valid, as illustrated by the delayed location of gate line signal falling edge 50 relative to data line signal falling edge 52 for the pixels at position PC. There is also a risk that pixel charging times will be undesirably shortened, as illustrated by the excessively reduced pixel charging time Tc that has resulted from the delayed position of data line signal falling edge 56 relative to gate line signal falling edge 54 (effectively causing gate line signal edge 54 to fall too soon) for the pixels at position PB.

To compensate for the timing issues caused by these signal delays, the timing of the gate line signals in different rows may be adjusted as a function of gate line position in display 14 and/or the timing of the data line signals in different columns may be adjusted as a function of data line position in display 14. Gate line driver circuitry 20B can be configured to produce gate line signals (or sets of gate line signals) that are asserted at progressively delayed times as a function of increasing row position (i.e., increasing distance from display driver circuitry 20A) to compensate for data line delay. Data line driver circuitry 20A can be configured to produce data line signals (or sets of data line signals) that are asserted at progressively delayed times as a function of column position (i.e., as a function of increasing distance from gate line driver circuitry 20A) to compensate for gate line delay.

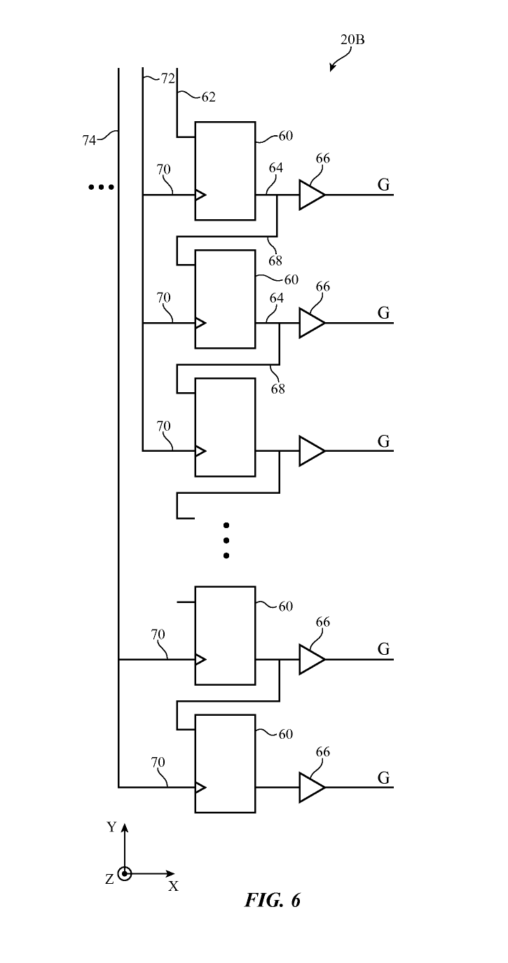

An illustrative configuration for gate line driver circuitry 20B that allows compensation for data line delay is shown in FIG. 6. As shown in FIG. 6, gate line driver circuitry 20B may contain a shift register formed from a chain of registers 60. Registers 60 are coupled in series, so that the output of each register serves as the trigger input to a subsequent register in the shift register. The trigger signal for the first register 60 may be received from gate start pulse line 62. Gate start pulse line 62, which, along with clock lines such as clock lines 72 and 74 forms part of signal path 38 of FIG. 2, may receive signals from display driver circuitry such as data line driver circuitry or other display driver circuitry 20 (e.g., circuitry 20A).

Each register 60 has an output 64 that produces an output signal. Gate line buffers 66 may drive the output signal from each output 64 onto a corresponding gate line, thereby creating a gate line pulse (gate line signal) for an associated row of pixels 22 in display 14. The output signal on each output 64 may be passed by a trigger signal path 68 that is coupled to that output 64 to the trigger input of a successive register 60, thereby forming the shift register.

Clocks on clock inputs 70 of registers 60 are used to clock the shift register and thereby establish the rising and falling edges of the gate line signals. The clocks may be multiphase clocks (as an example). To advance the rising edges of the gate line signals on some gate lines relative to others, different sets of clock inputs 70 may be clocked by clocks with different relative timings (i.e., increasing amounts of delay as a function of increasing distance from the edge of display 14 on which data line driver circuitry 20A is located).

As an example, in a display with 1000 lines, there may be four clock signal lines each of which distributes a differently delayed clock to a different respective set of registers 60 (e.g., a first clock signal to registers 1-250, a second, somewhat delayed, clock signal to registers 251-500, a third clock signal with additional delay to registers 501-750, and a fourth clock signal with yet further delay to registers 751-100). There may be any suitable number of registers in each set of registers (e.g., 5 or more, 10 or more, 50 or more, 100 or more, 250 or more, etc.). There is preferably a sufficiently small number of registers in each set of registers to ensure that the timing difference between successive sets of registers is relatively small and therefore results in a smooth transition between each set of registers. The present example in which there are 250 registers in each set of registers is merely illustrative.

In the illustrative configuration of FIG. 6, clock line 72 is being used to deliver a first clock having a first clock timing to clock inputs 70 in a first set of registers 60 and clock line 74 is being used to deliver a second clock having a second clock timing to a second set of registers 60. The second set of registers (in this example) is located further away from the data line driver circuitry 20A, and is therefore in need of a delayed gate line signal relative to the first set of registers. This can be accomplished by delaying the location of the clock edges for the clock on line 74 relative to the clock on line 72 using the clock generation circuitry of data line driver circuitry 20A or other display driver circuitry. In displays with numerous clock lines each of which supplies a differently delayed clock to a different respective sets of registers 60 in a different set of rows, the clock for each successive set of registers may have a progressively delayed timing, thereby smoothly compensating for data line delays even in displays with large numbers of rows. To compensate for gate line delays, the data line signals on the data lines in different columns (or sets of columns) may likewise be progressively delayed by data line driver circuitry 20A as a function of increasing distance from the gate line driver circuitry.

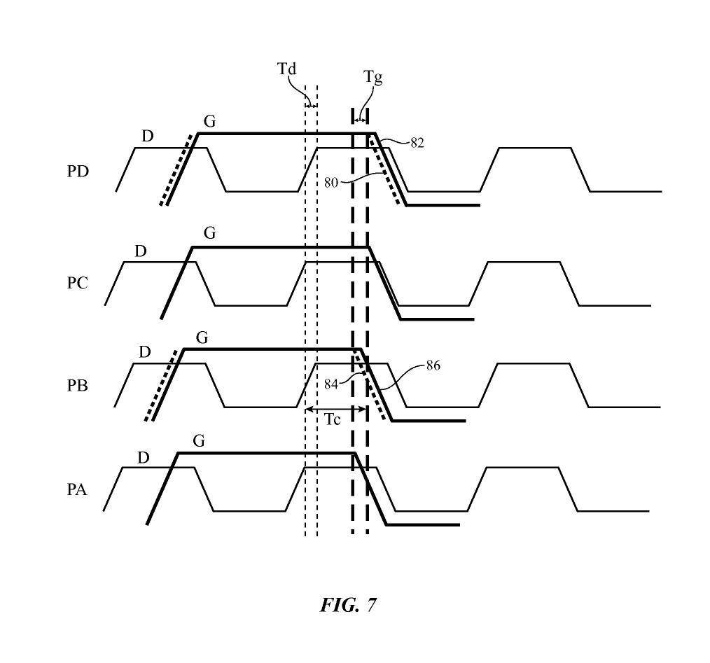

FIG. 7 is a timing diagram illustrating the impact of adjusting gate line signal timing to compensate for data line delay without compensating for gate line delay. As shown in FIG. 7, the gate line signals G for pixels in positions PD and PB have been delayed relative to the gate line signals G for pixels in positions PA and PC. For the pixels of position PD, for example, falling gate line signal edge 80 is delayed as illustrated by delayed gate line signal edge 82 using circuitry of the type shown in FIG. 6. Similarly, the pixels of position PB have a gate line signal G with delayed falling edge 86 instead of falling edge 84. With this arrangement, the pixels in position PD will have the same timing margin (separation between edge 82 and the falling edge of the data signal) as the pixels in position PC, while the pixels in position PB will have an enhanced pixel charging time Tc. Moreover, the difference in pixel charging times between different positions is reduced. This results in more consistent pixel charging voltages and improved display performance.

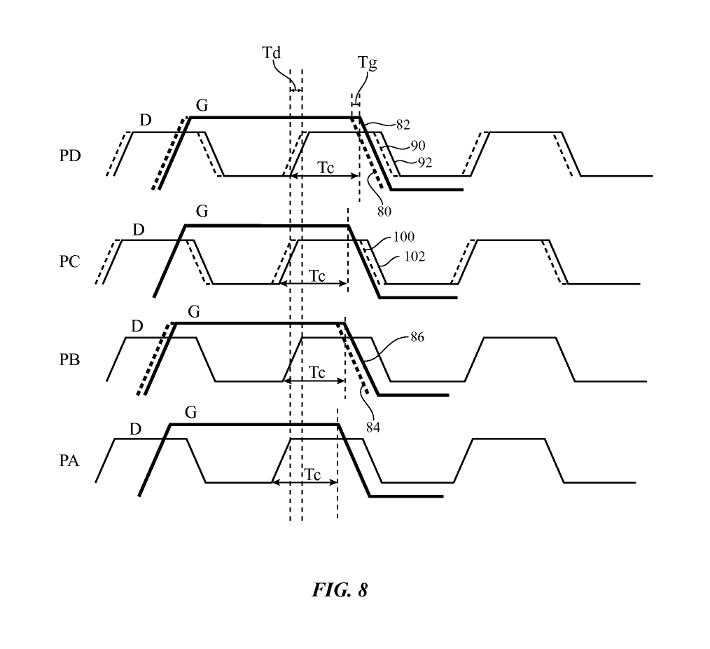

If desired, both gate line delay and data line delay may be compensated. This type of scenario is illustrated in FIG. 8. In the example of FIG. 8, increasing amounts of gate line signal delay have been added to the gate lines in display 14 as a function of increasing distance from data line driver circuitry 20A (i.e., increasing distance from the upper edge of the pixel array towards the lower array of the pixel array) and increasing amounts of data line signal delay have been added to the data lines in display 14 as a function of increasing distance from gate line driver circuitry 20A (i.e., increasing distance from the left edge of the pixel array towards the right edge of the pixel array). As a result, gate line signal G for the pixels in location PD is delayed so that gate line signal falling edge 80 becomes delayed gate line signal falling edge 82 to compensate for data line delay and data line signal D for the pixels in location PD is delayed so that data line signal falling edge 90 becomes delayed data line signal falling edge 92 to compensate for gate line delay. For pixels in location PC, gate line signal G is not delayed (because there is no data line signal delay along the top edge of the display of FIG. 4) and data line signal D is delayed so that data line signal falling edge 100 becomes delayed data line signal falling edge 102 to compensate for gate line delay. For pixels in location PB, data line signal D is not delayed (because there is no gate line signal delay along the left edge of display 14) and gate line signal G is delayed so that gate line signal falling edge 84 becomes delayed gate line signal falling edge 86 to compensate for data line delay. For pixels in location PA, gate line signal G is not delayed (because there is no data line delay along the upper edge of display 14 of FIG. 5) and data line signal D is not delayed (because there is no gate line delay along the left edge of display 14 of FIG. 5). As illustrated by the relative positions of the gate line signal falling edges and the data line signal falling edges of the compensated display that are shown in FIG. 8, compensating for date line delay and gate line delay may help ensure satisfactory pixel charging time and timing margin for all of the pixels of display 14, regardless of location.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
an array of pixels; and
display driver circuitry that has data line driver circuitry that provides data line signals to columns of the pixels on data lines and that has gate line driver circuitry that provides gate line signals to rows of the pixels on gate lines so that gate line signals on different rows are timed differently with respect to the data line signals to compensate for data line delays experienced by the data line signals on the data lines.

2. The display defined in claim 1 wherein the display driver circuitry produces a plurality of different clock signals and wherein the gate line driver circuitry includes a plurality of sets of registers, each set of registers being associated with a respective successive set of rows of the pixels and receiving a respective one of the plurality of different clock signals.

3. The display defined in claim 2 wherein the clock signals for the sets of registers are delayed by increasing amounts as a function of increasing distances of the sets of registers from the data line driver circuitry to progressively delay the gate line signals and compensate for the data line delays.

4. The display defined in claim 3 wherein the data line driver circuitry is configured to delay the data line signals by increasing amounts as a function of increasing distance from the gate line driver circuitry to compensate for gate line delays experienced by the gate line signals on the gate lines.

5. The display defined in claim 1 wherein the gate line driver circuitry is located along an edge of the array of pixels and wherein the data line driver circuitry delays the data line signals by increasing amounts as a function of increasing distance from the gate line driver circuitry to compensate for gate line delays experienced by the gate line signals on the gate lines.

6. The display defined in claim 1 wherein the pixels comprise liquid crystal display pixels each of which includes a thin-film transistor having a gate controlled by one of the gate line signals.

7. The display defined in claim 6 wherein the array of pixels has first and second opposing edges and third and fourth opposing edges and wherein the gate line driver circuitry extends along the third edge and wherein the data line driver circuitry extends along the first edge.

8. The display defined in claim 7 wherein the data line signals experience the data line delays when traveling away from the first edge along the data lines towards the second edge, wherein the gate line driver circuitry includes registers, and wherein each of the registers provides a respective one of the gate line signals to a respective one of the rows of pixels.

9. The display defined in claim 8 wherein the registers are provided with increasingly delayed clocks at increasing distances of the registers from the first edge towards the second edge to compensate for the data line delays.

10. The display defined in claim 9 wherein the registers are controlled by clock signals and wherein the registers receive clock signals that are delayed by increasing amounts as a function of distance of the registers from the first edge towards the second edge.

11. The display defined in claim 10 wherein the data line driver circuitry delays the data line signals on the data lines by increasing amounts as a function of increasing distance of the data lines from the third edge towards the fourth edge to compensate for gate line delays experienced by the gate line signals on the gate lines.

12. A display, comprising:
an array of pixels having first and second opposing edges and third and fourth opposing edges;
data line driver circuitry that extends along the first edge and that provides data line signals to columns of the pixels on data lines; and
gate line driver circuitry that extends along the third edge and that provides gate line signals to rows of the pixels on gate lines, wherein the gate line driver circuitry has registers that receive a plurality of progressively delayed clocks at increasing distances of the registers from the first edge to the second edge so that the gate line signals on the gate lines are delayed by increasing amounts as a function of increasing distance of the gate lines from the first edge towards the second edge to compensate for data line propagation delays experienced by the data line signals on the data lines.

13. The display defined in claim 12 wherein each of the rows of pixels comprises liquid crystal display pixels that each have a thin-film transistor that is controlled by the gate line signal in that row.

14. The display defined in claim 13 wherein the gate line signals are characterized by gate line signal propagation delays associated with propagation of the gate line signals from the third edge towards the fourth edge along the gate lines and wherein the data line driver circuitry is configured to compensate for the gate line signal propagation delays.

15. The display defined in claim 14 wherein the data line driver circuitry is configured to impose compensating data line signal delays on the data line signals provided to the data lines that increase as a function of distance of the data lines from the third edge towards the fourth edge to compensate for the gate line signal propagation delays.

16. The display defined in claim 15 wherein the registers of the gate line driver circuitry are coupled in series to form a shift register.

17. The display defined in claim 16 wherein each of the sets of the registers is clocked by a different one of the progressively delayed clocks.

18. The display defined in claim 17 wherein each of the sets of registers contains at least ten registers.

19. A liquid crystal display, comprising:
an array of pixels having first and second opposing edges and third and fourth opposing edges, wherein each pixel has liquid crystal material and a thin-film transistor that controls application of signals to the liquid crystal material;
data lines that extend parallel to the third and fourth opposing edges;
gate lines that extend parallel to the first and second opposing edges;
data line driver circuitry that extends along the first edge and that provides data line signals to columns of the pixels on the data lines; and
gate line driver circuitry that extends along the third edge and that provides gate line signals to rows of the pixels on the gate lines, wherein the data line driver circuitry is configured to impose increasing delays on the data line signals on the data lines as a function of increasing distance of the data lines from the gate line driver circuitry to compensate for gate line signal propagation delays as the gate line signals propagate on the gate lines from the third edge towards the fourth edge.

20. The liquid crystal display defined in claim 19 wherein the gate line driver circuitry has registers that are coupled in series to form a shift register and wherein sets of the registers receive increasingly delayed clocks as a function of increasing distances of the sets of registers from the first edge to the second edge so that the gate line signals on the gate lines are delayed by increasing amounts as a function of increasing distance of the gate lines from the first edge towards the second edge, thereby compensating for propagation delays experience by the data line signals as the data line signals propagate on the data lines from the first edge towards the second edge.
